(19) United States
(12) Patent Application Publication
(10) Pub. No.: US 2005/0037194 A1
(43) Pub. Date: Feb. 17, 2005

(54) Thermoplastic polymers with thermally reversible and non-reversible linkages, and articles using same

(75) Inventors: Sharon Linda Greene, Canton, GA (US); Archel A. Ambrosio, San Diego, CA (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/641,858

(22) Filed: Aug. 15, 2003

(51) Int. Cl. B41M 3/00

(52) U.S. Cl. 428/364

(57) ABSTRACT

The invention provides a polymer adapted for use in melt processes, the polymer having thermally reversible and non-thermally reversible bonds which polymer is adapted to evanesce at an elevated temperature and revert to a thermally reversible bond upon cooling to ambient temperature so that the polymer is adapted, upon being heated to the elevated temperature, to dissociate into melt processable polymeric fragments and, upon being cooled to ambient temperature, to re-associate.

### FIELD OF THE INVENTION

The present invention relates to thermoplastic polymers, and articles using the same.

### BACKGROUND OF THE INVENTION

Aromatic urethane bonds are known to evanesce at elevated temperatures leaving behind aromatic alcohols and aromatic isocyanates. This phenomenon is used to form water-based urethane coatings that are stable at room temperature. Such coatings contain isocyanates which have been reacted with a material such as, for example, phenol, to create a reversible aromatic urethane bond. Isocyanates that are blocked in this manner are unable to react at room temperature with compounds that normally react with isocyanates but will react at temperatures which cause the aromatic urethane bond to evanesce.

High molecular weight polyurethane polymers containing only thermally reversible linkages are known. Such thermoplastic polymers are adapted for use in melt processes. In particular such polymers are adapted to evanesce at an elevated temperature and revert upon cooling to ambient temperatures so that the polymer, upon being heated to the elevated temperature, dissociates into melt-processable polymeric fragments and, upon being cooled to ambient temperatures, re-associates. However, while such polyurethane polymers offer the advantage of a lower viscosity of the melt during processing, thus reducing the die-tip pressure during extrusion and improving throughput, the molecular weight of such polymers is significantly reduced if moisture is present, when the linkages are temporarily broken. As a result, the material's melt strength is compromised.

Further, the long term physical attributes of such polymeric materials are compromised, in that the polymers experience significant color change after subsequent melting and cooling cycles or with ultraviolet light exposure, over time. Such discoloration (such as turning from clear to a yellow/tan color, or to a darker yellow or brown hue), are problematic for certain end-use product applications, especially where aesthetic appearances are of concern. It has likewise been found that such color change may also be accompanied with reduced polymer strength. Such polymers are often brittle, and easily shatter over time.

Polyurethanes with only non-reversible linkages are also known. While such polymers maintain their molecular weight and hence, their melt strength during thermal processing, such materials demonstrate relatively high viscosity. As a result of such high viscosity, such thermoplastic materials create high die-tip pressure which is undesirable from a processing point of view, as elevated die-tip pressures can lead to slower processing/extrusion speeds and increased wear and tear on the processing equipment.

Certain mixes of thermally reversible and non-thermally reversible polyurethane polymers are known as well. Such published mixes are indiscriminate in nature (in that they do not appear to be focused on particular concentrations for particular end uses), and include low number average molecular weight starting materials.

Polymeric products such as extrusion molded articles, and film and nonwoven sheet materials requiring strength and toughness, are typically formed from high molecular weight polymers. These polymers usually have low melt flow rates and are normally processed at temperatures near the polymer's degradation temperature to improve processability. The resulting products may contain polymers that are partially degraded, causing a loss of desired physical properties. In some situations, high molecular weight polymers may be partially degraded by overheating to increase the melt flow rate of the polymer to a useful range for processing.

There is therefore a need for melt processable thermoplastic polymers which offer reduced die tip pressure, and which also are of relatively high molecular weight and which demonstrate relatively high melt strengths. Such high molecular weight polymers would be particularly useful for several product applications, including wound-care type products. There is a further need for such polymers which retain their general coloration over numerous melt/cooling cycles and which are of relatively low viscosity. There is a further need for such polymers which are hydrophilic in nature. It is to such needs that the present application is directed.

### Definitions

As used herein, the term “thermally reversible bond” refers to a chemical bond which is capable of evanescence and reversion such as, for example, an aromatic urethane bond. Generally speaking, evanescence and reversion of a thermally reversible bond is an equilibrium process. Above a threshold temperature, evanescence of the bond is favored. Below a threshold temperature, reversion of the bond is favored. The temperature of evanescence and reversion of a thermally reversible aromatic urethane bond may be altered by substituting electron donating or electron withdrawing substituents at a location where they are capable of donating electrons to or withdrawing electrons from the thermally reversible bond.

As used herein, the term “non-thermally reversible bond” refers to a chemical bond which is not capable of evanescence and reversion as described above, and which remains relatively stable over a range of temperatures, until such temperatures at which it irreversibly/permanently degrades/evanesces.

As used herein, the term “soft segment” refers to an amorphous or slightly crystalline portion of a polymer. Typical soft segments may be formed from aliphatic polyethers or aliphatic polyesters having number average molecular weights from about 500 to about 25,000. Other soft segments may be formed from, for example, polyethylene glycol, polytetramethylene ether glycol, hydroxyl-terminated polyesters, polypropylene glycols, hydroxyl-terminated polydimethylsiloxanes, polyesters, nylons/polyamides, polyolefins, polycarbonates and polyureas.

As used herein, the term “hard segment” refers to a glassy or highly crystalline portion of a polymer, the portion being formed from molecules that are substantially rigid and symmetrical. A hard segment may be formed from, for example, a short chain oligomer of a polyurethane or polyurea. A hard segment may contain molecules which are bridged by a thermally reversible bond that evanesces upon exposure to heat.

As used herein, the term “thermally reversible polymer” refers to a polymer formed by the chemical linking of soft segments by hard segments that includes both thermally reversible bonds and non-thermally reversible bonds.

As used herein, the term “polymer fragment” refers to a piece of polymer formed upon the evanescence of a thermally reversible bond of a thermally reversible polymer. A polymer fragment includes at least one soft segment and a part of the hard segment that, prior to evanescence, adjoined the thermally reversible bond.

As used herein, the term “degradation temperature” refers to the temperature at which chemical bonds evanesce in an irreversible manner because of irreversible chemical reactions.

As used herein, the term “low molecular weight” refers to number average molecular weight unless otherwise described, and specifically refers to a pre-polymer segment component, having a number average molecular weight less than about 3,000.

As used herein, the term “pre-polymer segment component” shall refer to a free, polymer forming component prior to being formed within a polymer, such as for instance, free polyethylene glycol or free polytetramethylene ether glycol.

As used herein, the term “high molecular weight” refers to number average molecular weight, unless otherwise described, and specifically refers to a pre-polymer segment component, having a number average molecular weight greater than about 3,000.

As used herein, the “weight average molecular weight” is determined by gel permeation chromatography and a calibration curve of six polymethyl methacrylate standards.

As used herein, the term “melt process” refers to methods of forming products from molten thermoplastic polymers. Exemplary methods include meltblowing, spunbonding and film extrusion. Meltblowing processes are disclosed in, for example, U.S. Pat. No. 3,849,241 to Butin. Spunbonding processes are disclosed in, for example, U.S. Pat. No. 4,340,563 to Appel et al., U.S. Pat. No. 3,692,618 to Dorschner et al., U.S. Pat. No. 3,802,817 to Matsuki et al., U.S. Pat. Nos. 3,338,992 and 3,341,394 to Kinney, and U.S. Pat. No. 3,542,615 to Dobo et al. These patents are hereby incorporated by reference in their entirety.

As used herein, the term “meltblown fibers” means fibers formed by extruding a molten thermoplastic material through a plurality of fine, usually circular, die capillaries as molten threads or filaments into a high velocity gas (e.g. air) stream which attenuates the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers.

As used herein, the term “microfibers” means small diameter fibers having an average diameter not greater than about 100 microns, for example, having an average diameter of from about 0.5 micron to about 50 microns, or more particularly, microfibers may have an average diameter of from about 4 microns to about 40 microns. Microfibers having an average diameter less than about 0.5 micron are commonly referred to as ultrafine microfibers.

As used herein, the term “spunbond fibers” refers to small diameter fibers which are formed by extruding a molten thermoplastic material as filaments from a plurality of fine, usually circular, capillaries of a spinnerette with the diameter of the extruded filaments then being rapidly reduced as by, for example, eductive drawing or other well-known spunbonding mechanisms.

As used herein, the term “sheet” means a layer which may either be a film or a nonwoven web.

As used herein, the term “nonwoven web” means a web having a structure of individual fibers or threads which are interlaid, but not in an identifiable, repeating manner.

As used herein, the term “chain extender” refers to an aromatic or aliphatic compound capable of reacting with at least two isocyanate terminated polymer units to form a polymer chain. Exemplary chain extenders may be aromatic or aliphatic compounds which are terminated with more than one hydroxyl or amine groups. If a chain extender is used to form a thermally reversible aromatic urethane bond, at least one of the functional groups of the chain extender should be a hydroxyl group attached directly to an aromatic ring.

As used herein, the term “polymer” generally includes, but is not limited to, homopolymers, copolymers, such as, for example, block, graft, random and alternating copolymers, terpolymers, etc., and blends and modifications thereof. Furthermore, unless otherwise specifically limited, the term “polymer” shall include all possible geometrical configurations of the material.

As used herein, the term “consisting essentially of” does not exclude the presence of additional materials which do not significantly affect the desired characteristics of a given composition or product. Exemplary materials of this sort would include, without limitation, pigments, antioxidants, stabilizers, surfactants, waxes, flow promoters, solvents, particulates and materials added to enhance processability of the composition.

As used herein, the term “wound care devices” shall encompass topical wound dressings, such as wraps, bandages, bandage strips, and similar protective wound coverings. Examples of wound care devices may be found in U.S. Pat. Nos. 4,551,490, 4,545,372, 4,977,892, 5,902,600, and 6,180,132 which are each incorporated in its entirety herein by reference.

As used herein, the term “drug delivery devices” shall encompass devices meant to be applied to the skin of a consumer, for delivering a substance contained in the device topically or transdermally to the consumer, as well as devices which provide for transmucosal and vaginal delivery. Examples of drug delivery devices may be found in U.S. Pat. Nos. 4,908,213, 5, 298,256, 5,494,680, 5,662,926, 5,814,329, 6,214,374 B1, and 6,264,981 and EP0384266A2, which are each incorporated in their entirety herein by reference. Additionally, hydrogel type products are also contemplated within the definition of wound care devices, such as those available from Amarin and CeNeS Drug Delivery Ltd. Of the United Kingdom.

As used herein the term “laminate” refers to a composite structure of two or more sheet material layers that have been adhered through a bonding step, such as through adhesive bonding, thermal bonding, point bonding, pressure bonding, entanglement or ultrasonic bonding.

### SUMMARY OF THE INVENTION

The present invention addresses problems associated with melt-processing high molecular weight polymers by providing a polymer adapted for use in melt processes, the polymer having thermally reversible bonds which are adapted to evanesce at an elevated temperature and revert upon cooling to ambient temperature so that the polymer is adapted, upon being heated to the elevated temperature, to dissociate into melt processable polymeric fragments and, upon being cooled to ambient temperature, to re-associate, but also having at least a certain percentage of non-thermally reversible bonds, to allow for color stability, melt strength, and product strength.

The thermally reversible polymer may be melt-processed to form materials having the valuable physical properties of high molecular weight polymers such as strength and toughness, while having the useful melt-processing characteristics of low molecular weight polymers such as high melt flow rates at lower temperatures. Further, the thermally reversible polymer demonstrates hydrophilicity for particular usefulness in wound-care product applications and drug delivery devices, since it is made from pre-polymer segments of high molecular weight. As a result, the synthesized polymer desirably demonstrates an overall weight average molecular weight of between about 70,000 and 100,000. In another alternative embodiment, the synthesized polymer demonstrates an overall weight average molecular weight between about 80,000 and 90,000.

According to the present invention, the thermally reversible polymer contains soft segments joined by hard segments that contains some thermally reversible bonds. The mole ratio of hard segments to soft segments within the synthesized polymer is desirably between about 2:1 and 4:1. More desirably, the mole ratio of hard segments to soft segments within the synthesized polymer is between about 2:1 and 3:1. Desirably, the ratio of non-reversible bonds to reversible bonds within the polymer (hard segments) is between about 1:1 and 4:1. In an alternative embodiment, the ratio of non-reversible bonds to reversible bonds within the polymer is between about 1:1 and 3:1. In another alternative embodiment, the ratio of non-reversible bonds to reversible bonds within the polymer is between about 2:1 and 4:1. Each of the pre-polymer segments is desirable of high molecular weight. In particular, it is desirable that the molecular weight of each of the pre-polymer segment component is greater than 3,000. Alternatively, the molecular weight of each of the pre-polymer segment component is between about 3,000 and 50,000. Still in a further alternative embodiment, the molecular weight of each of the pre-polymer segment component is between about 8000 and 20,000. Such high molecular weight pre-polymer segment components are desirable to provide a level of hydrophilicity to the synthesized polymer product. Such functionality is particularly desirable for wound care and drug delivery devices, so as to provide comfort to wound care materials, and also to encourage flow of medicaments or other treatments from drug delivery devices topically, transdermally, transmucosally, or vaginally.

The thermally reversible bonds of such synthesized polymers should be capable of evanescing at an elevated temperature which is lower than the degradation temperature of the polymer fragments. The thermally reversible bond may be, for example, an aromatic urethane bond.

Desirably, such synthesized polymer demonstrates the ability to withstand discoloration without the use of, or limited use of an ultraviolet light stabilizer added to the polymer mix. It is further desirable that materials made from the synthesized polymer, retain strength and flexibility as well as minimal or no alteration in color over a two year period when compared to similar thermally reversible polymers with all thermally reversible bonds between hard and soft segments. Further, it is desirable that such materials do not become brittle over such time period.

Desirably, the synthesized polymer is incorporated into a wound care material such as a nonwoven bandage, bandage strip or wrap. Alternatively, such synthesized polymer is incorporated into a drug delivery device, such as a transdermal patch made from a nonwoven or film sheet of the synthesized polymer, a transmucosal delivery device, a vaginal delivery device or a hydrogel-type drug delivery device.

### BRIEF DESCRIPTION OF THE DRAWINGS

FIG. 1 is a schematic illustration of an apparatus which may be used to form a nonwoven web of thermally reversible polymer fibers.

FIG. 2 is a bottom view of the die of FIG. 1 with the die having been rotated 90 degrees for clarity.

FIG. 3 is a cross-sectional view of the die of FIG. 1 taken along line 3-3 of FIG. 2.

FIG. 4 is an exploded perspective view of a wound care dressing/and transdermal delivery device which incorporates material of the invention.

FIG. 5 is a cross-sectional view of the transdermal delivery device of FIG. 4.

### DETAILED DESCRIPTION OF THE INVENTION

The thermally reversible polymer of the present invention contains soft segments joined by hard segments that contains thermally reversible and non-thermally reversible bonds. Each segment is described herein using prepolymer segment components, segment components and by general formula. The hard segments having thermally reversible bonds may contain a thermally reversible aromatic urethane bond. When the thermally reversible polymer contains hard segments containing thermally reversible aromatic urethane bonds, the polymer may have the following general formula: 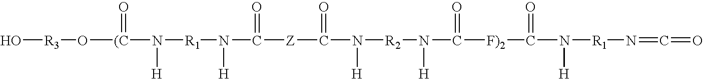
wherein R₁ is selected from aliphatic and aryl groups; wherein R₂ is selected from aliphatic and aryl groups so that the polymer has at least one R₂ which is an aryl group having from 6 to about 18 carbon atoms. For example, R₂ may be an aromatic compound selected from, for example, phenyl, biphenyl and naphthyl; x is an integer greater than or equal to 2; and Z is a soft segment.

The soft segment may be described, for example, by the following formulas: 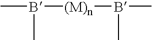
where B is selected from oxygen and sulfur and B′ is nitrogen; M is a repeating monomer unit such as, for example, an ether, ester, amide, olefin, carbonate, urea, urethane and siloxane; and n is an integer of from 60 to 600 so that the soft segment has a number average molecular weight greater than about 3,000, for example, from about 3,600 to about 60,000 as determined by titration.

When the hard segment includes a thermally reversible aromatic urethane bond, component F of the thermally reversible polymer depicts the chain extender which provides the hydroxyl portion of the urethane bond and may be represented by the following formulas: 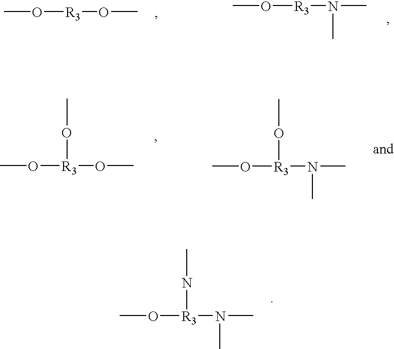
where R₃ is an aromatic group selected from, for example, sulfonyldiphenyl, amino phenyl, benzoic acid, phenyl acetic acid, thiodiphenyl, methyl phenyl, phenyl, biphenyl, and naphthyl.

Although the formula for component F depicts all the oxygen and/or nitrogen atoms pendant from the aromatic compound, only the oxygen atom which completes the urethane bond needs to be pendant to the aromatic groups in order to form a thermally reversible bond. The other oxygen and/or nitrogen atoms may be separated from the aromatic group by segments such as, for example, saturated and unsaturated alkyl chains and saturated and unsaturated cycloalkyl chains.

The aromatic group R₃ may be substituted with one or more electron donating substituents or electron withdrawing substitutents. Electron donating or electron withdrawing substituents affect the temperature at which the aromatic urethane bond evanesces and reverts. Although the inventors should not be held to a particular theory of operation, it is believed that the electron withdrawing substituents lower the temperature at which the thermally reversible aromatic urethane bond evanesces resulting in higher melt flow rates and lower processing temperatures for compositions containing such a thermally reversible bond. However, strong electron withdrawing substituents appear to diminish the rapid reversion of the evanesced bonds. Such an effect may be unsuitable in melt-processes where rapid formation of a polymer film, fiber or other material is desired.

Exemplary electron withdrawing substituents include nitro groups, sulfonyl groups, cyano groups, acetyl groups, esters, and amides. Aromatic groups having electron withdrawing substituents include, for example, amino phenyl, benzoic acid, and phenyl acetic acid groups.

Electron donating substituents are believed to increase the temperature at which the thermally reversible aromatic urethane bond evanesces and increase the rapid reversion of evanesced bonds. Those substituents can be used to adjust the melt flow rate for a given processing temperature as well as to enhance the rapid formation of films, fibers or other products made of polymers containing such a substituted thermally reversible bond. Exemplary electron donating substituents include alkoxy groups, alkyl groups, halides and tertiary amines.

Aromatic groups having electron donating substituents include, for example, thiodiphenyl, methyl phenyl and methoxy phenol groups. The relation between the electron withdrawing or donating substituents of aromatic component F and the evanescence and reversion of thermally reversible aromatic urethane bonds is described to illustrate that compositions may be developed to suit the requirements of particular melt-processing methods such as, for example, meltblowing processes, spun-bonding processes and film extruding processes. For example, compositions having low evanescence temperatures, high melt flow rates and rapid reversion of evanesced bonds may be desirable for many processes that produce polymer fibers such as, for example, meltblowing or spunbonding processes.

When the thermally reversible polymer contains a thermally reversible aromatic urethane bond, the reversible bonds may be formed by reacting an aromatic multifunctional isocyanate with an aromatic compound having at least one hydroxyl group attached to the aromatic ring. Generally speaking, most aromatic diols and/or triols, substituted aromatic diols and/or triols, mixed aromatic aliphatic alcohols, aromatic alcohols/amines, aromatic alcohols/thiols, and aromatic alcohols/carboxylic acids could be reacted with many aromatic isocyanates to generate the thermally reversible urethane bond.

Polymers containing thermally reversible urethane bonds are typically prepared by (1) reacting a hydroxyl terminated or amine terminated polymer with an aromatic multifunctional isocyanate; and (2) reacting the product from the first step with a chain extender having at least two functional groups capable of reacting with the isocyanate, at least one of the functional groups being a hydroxyl group attached to an aromatic ring.

Soft segments joined by hard segments without thermally reversible bonds are produced in the first reaction. Hard segments having thermally reversible urethane bonds are produced in the second reaction. The desirable mole ratio of hard segments to soft segments is between 2:1 and 4:1. More desirably, the mole ratio of hard segments to soft segments is between 2:1 to 3:1. Desirably, the ratio of non-thermally reversible hard segment bonds to thermally reversible hard segment bonds is between about 1:1 to 4:1. More desirably the ratio of non-thermally reversible hard segment bonds to thermally reversible hard segment bonds is between about 2:1 to 4:1.

Exemplary hydroxyl-terminated polymers include polyethylene glycols having molecular weights of 3350, 4000, 4600 and 8000 available from the Union Carbide Corporation under the trade designation Carbowax; polyethylene adipate diol available from the Mobay Corporation under the trade designation Desmophen 2000; polytetramethylene ether glycol polymer having molecular weights of 1000 and 2900 available under the trade designation Terathane from E. I. DuPont de Nemours & Company, and polycaprolactone diol available from the Aldrich Chemical Company. Other useful hydroxylterminated polymers include polysiloxane diols and polypropylene glycols. Each soft segment desirably has a number average molecular weight (Mn) in the range from about 1,000 to about 50,000.

Desirably, soft segments may be formed from PEGs such as Union Carbide Sentry Grade PEG having number average molecular weights between about 3000 and 50,000. More desirably, such soft segments may be formed from such PEGs having number average molecular weights between about 8000 and 20,000. Desirably such soft segments may also be formed from PTMEGs such as those available from DuPont under the Terethane brand. If PTMEG are to be utilized, it is desirable that such PTMEG have number average molecular weights between about 1000 and 3000. More desirably, such PTMEGs have number average molecular weights between about 1000 and 2000. If PPGs are utilized, such as those available from Dow under the Carbowax brand, such PPGs desirably have number average molecular weights between about 400 and 4000, and more desirably between about 1000 and 2000. If one were to use higher molecular weight soft segments, the polymer diols can first be coupled together before forming the hard segment part. For instance, three PEGs can be coupled together using, methylene diphenyl diisocyanate (MDI) in order to form a PEG-MDI-PEG-MDI-PEG chain of approximately 24,000 number average molecular weight.

Certain physical properties of the thermally reversible polymer may be varied by changing the types of soft segments thus allowing the polymer to be tailored for differ ent applications. For example, if a hydrophilic polymer is desired, a polyethylene glycol soft segment with higher molecular weight may be used as one of the starting materials. Thermoplastic elastomers can also be formed with soft segments such as, for example, polytetramethylene ether glycol, hydroxyl-terminated polyesters, polypropylene glycols, and hydroxyl-terminated polydimethylsiloxanes. The thermally reversible bond may be introduced into many types of polymeric systems such as, for example, one or more polyesters, nylons/polyamides, polyolefins, polycarbonates and polyureas.

Thermally reversible (aromatic multifunctional) isocyanates (containing at least one aromatic alcohol) found to be useful include, for example, toluene-2,4-diisocyanate, toluene-2,6-diisocyanate, 4,4′-methylenebis(phenylisocyanate), m-phenylene diisocyanate, 4,4′-biphenylene diisocyanate, 3,3′-dichloro-4,4′-biphenylene diisocyanate, xylene diisocyanate, chlorophenylene diisocyanate, diphenyl-methane-4,4′-diisocyanate, naphthalene-1,5-diisocyanate, methylene diphenyl diisocyanate (MDI). An example of a non-thermally reversible isocyanate includes hexamethylenediisocyanate.

The aromatic chain extender utilized in the second reaction should have at least two functional groups capable of reacting with the isocyanate and at least one of those groups should be a hydroxyl group attached directly to an aromatic ring. Exemplary chain extenders include aromatic diols having at least one hydroxyl group attached directly to the aromatic ring and mixtures of such aromatic diols and aliphatic diols. The chain extender may also include aromatic compounds having at least one hydroxyl group attached directly to an aromatic ring and one or more amino groups such as, for example, 2,4-dihydroxyl-N-(2-hydroxylethyl) benzamide. Other exemplary thermally reversible chain extenders (containing at least one aromatic alcohol) include Resorcinol, 4-aminophenol, 4-hydroxybenzyl alcohol, 4-hydroxy-3-methoxybenzyl alcohol (vanillyl alcohol), 2-(2-hydroxyethoxy)phenol. Exemplary non-thermally reversible chain extenders are butanediol (BDO), hexanediol, and cyclohexanediol.

It should be noted that in selecting specific hard and soft segment compositions, the exact type of thermally reversible and non-thermally reversible segments can be altered depending on the properties sought.

Polymers having elastic characteristics may be produced utilizing para-substituted phenylene diol chain extenders such as, for example, hydroquinone, methylhydroquinone, phenylhydroquinone, acetyl hydroquinone, 4,4′-isopropylidenediphenol, chlorohydroquinone, biphenol, methylene bisphenol and thiodiphenol. Polymers having elastic characteristics may also be produced utilizing derivatives of para-substituted phenol chain extenders such as, for example, 4-amino phenol, 4-hydroxyl-benzoic acid, 4-hydroxylphenyl acetic acid and 4-hydroxylbenzyl alcohol. Polymers having elastic characteristics may also be produced utilizing mixtures of 1,4-phenylene diol chain extenders or parasubstituted phenol derivatives and other aromatic and/or aliphatic diols. For example, elastic polymers may be prepared utilizing a mixture of 1,4-dihydroxyl benzene and 1,3-dihydroxyl benzene. Although the inventors should not be held to a particular theory of operation, it is believed that chain extenders which include para-substituted phenylene compounds or ring systems having one or more para-substituted phenylene groups increase the degree of crystallinity of the resulting polymer causing distinct phase separation between the hard and soft segments. It is believed that this phase separation imparts elastic properties to the polymer. Generally speaking, mixtures containing more than 50% by weight 1,4-phenylene diol or 1,4-phenylene diol derivatives result in polymers having elastic characteristics.

A structural equation of an exemplary thermally reversible urethane linkage is as follows:

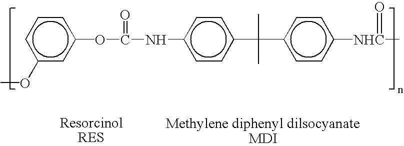

A structural equation of an exemplary non-thermally reversible urethane linkage is as follows:

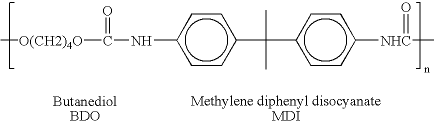

A structural equation of an exemplary urethane with mixed non reversible and reversible hard segments is as follows. For the purposes of the structural equation “PEG” is representative of polyethylene glycol, and “RES” is representative of Resorcinol.

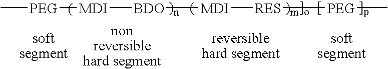

The ratios of n:m and (n+m=o):p are varied as described herein.

A structural equation illustrating the thermally reversible chemistry depicting the evanescing and reassociating after heating, is shown as follows:

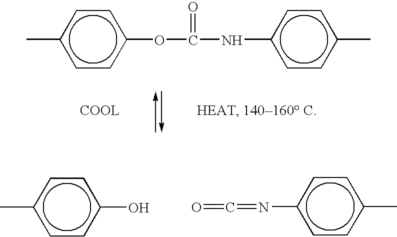

In such an example, for ease of processing, the melt-processing temperature of the polymer could be between 185 and 190° C., for example.

Desirably, the weight average molecular weight of the thermally reversible polymers produced from these synthesis reactions may range from about 70,000 to about 100,000 as determined by Gel Permeation Chromatograghy methods, using polymethyl methacrylate calibration standards. More desirably, the weight average molecular weight may range from about 80,000 to about 90,000. In particular, if such polymers are to be used in meltblowing processing applications, it is desirable that such polymeric weight average molecular weight (as determined by GPC) be between about 70,000 and 100,000. More desirably, such weight average molecular weight is between about 70,000 and 80,000. If such polymers are to be used in a melt spinning (spunbond) processing application, it is desirable for such weight average molecular weight to be between about 70,000 and 100,000. It is more desirable that such range be between about 90,000 and 100,000. Desirably the melt flow rate of such polymers is between about 70-500 grams per 10 minutes (g/10 min.) for meltblowing applications at the processing temperature. More desirably, such meltflow rate is between about 100 and 400 g/10 min. For meltspinning applications, it is desirable for the meltflow rate to be between about 35 and 400, but more desirably between about 50-100 g/10 min. These melt flow rates are calibrated with ½ size orifices (0.0411 inches). All of these rates are at temperatures from 145-205° C.

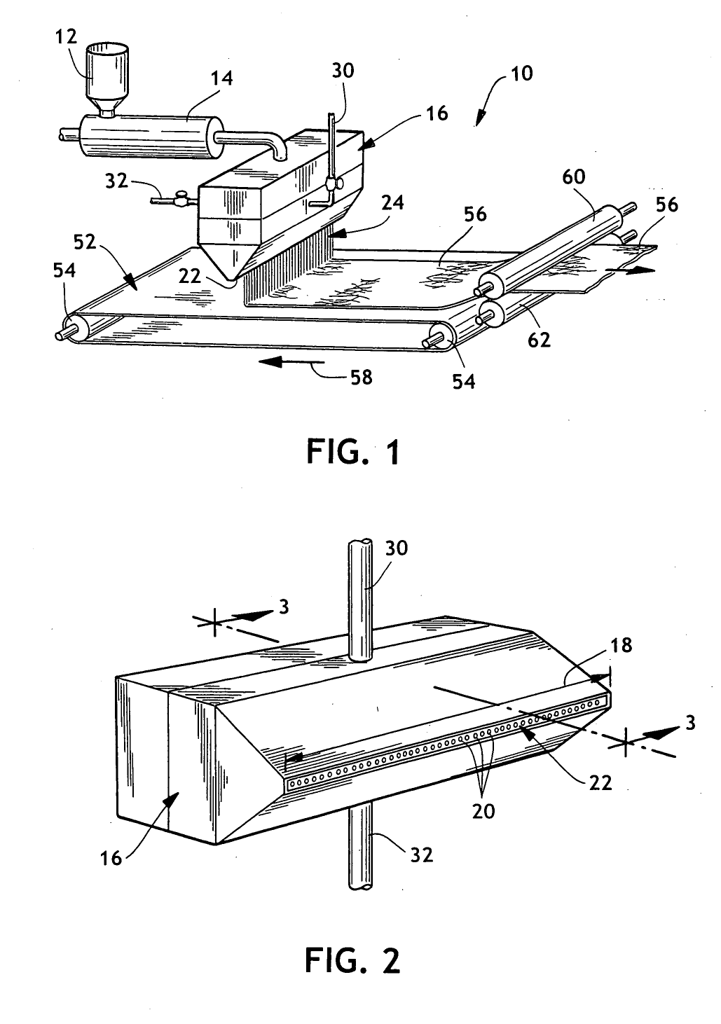

Turning now to the figures wherein like reference numerals represent the same or equivalent structure and, in particular, to FIG. 1 where it can be seen that an apparatus for forming a nonwoven web of meltblown thermally reversible polymer fibers of the present invention is schematically generally represented by reference numeral 10. In forming the fibers and a nonwoven web of the present invention, pellets or chips, etc. (not shown) of a thermally reversible polymer are introduced into a pellet hopper 12 of an extruder 14. The extruder 14 has an extrusion screw (not shown) which is driven by a conventional drive motor (not shown). As the thermally reversible polymer advances through the extruder 14, due to rotation of the extrusion screw by the drive motor, it is progressively heated to a molten state where the thermally reversible bonds evanesce and polymer fragments are formed. Heating the thermally reversible polymer to the molten state may be accomplished in a plurality of discrete steps with its temperature being gradually elevated as it advances through discrete heating zones of the extruder 14 toward a meltblowing die 16. The die 16 may be yet another heating zone where the temperature of the thermoplastic resin is maintained at an elevated level for extrusion. The temperature which will be required to heat the thermally reversible polymer to a molten state will vary, depending upon factors such as, for example, the type of polymers between the thermally reversible bonds, presence of electron withdrawing or electron donating substituents on the aromatic chain extender, and addition of cross-linking agents to the thermally reversible polymer. Generally speaking, typical thermally reversible polymers may be extruded within the temperature range of from about 150 degrees Centigrade to about 200 degrees Centigrade. For example, the extrusion may be accomplished within a temperature range of from about 170 degrees Centigrade to about 190 degrees Centigrade. Heating of the various zones of the extruder 14 and the meltblowing die 16 may be achieved by any of a variety of conventional heating arrangements (not shown).

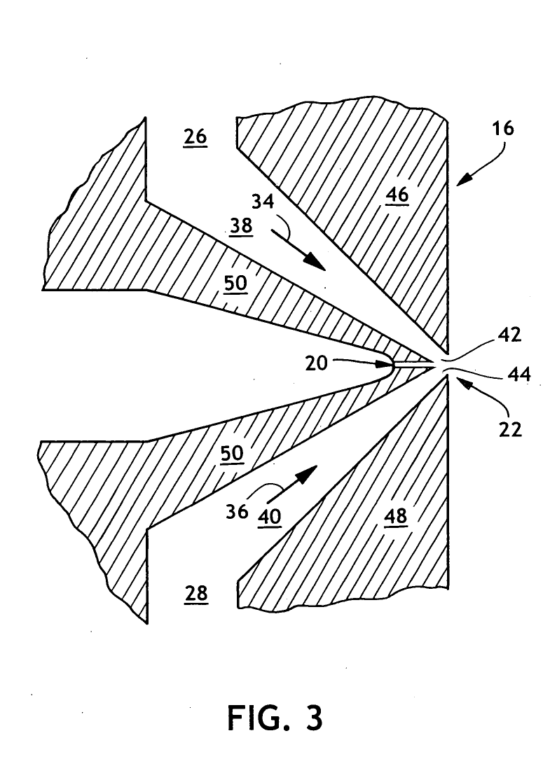

FIG. 2 illustrates that the lateral extent 18 of the die 16 is provided with a plurality of orifices 20 which are usually circular in cross-section and are linearly arranged along the extent 18 of the tip 22 of the die 16. The orifices 20 of the die 16 may have diameters that range from about 0.01 inches to about 0.20 inches, for example. For example, the orifices may have a diameter of about 0.0145 inches and a length of about 0.113 inches. Orifices having a diameter even less than 0.01 inches may also be used because of the very low viscosities of the thermally reversible polymers. For example, orifices having a diameter of about 0.005 inches may be used to produce ultrafine microfibers. From about 5 to about 50 orifices may be provided per inch of the lateral extent 18 of the tip 22 of the die 16 with the die 16 extending from about 30 inches to about 60 inches or more. It is desirable to use fewer than 5 orifices per inch when the orifices have a diameter of less than 0.01 inches to avoid pressure damage to the die tip.

FIG. 1 illustrates that the molten thermally reversible polymer fragments emerge from the orifices 20 of the die 16 as molten strands or threads 24. FIG. 3, which is a cross-sectional view of the die of FIG. 2 taken along line 3-3, illustrates that the die 16 preferably includes attenuating gas inlets 26 and 28 which are provided with heated, pressurized attenuating gas (not shown) by attenuating gas sources 30 and 32. (See FIGS. 1 and 2.) The heated, pressurized attenuating gas enters the die 16 at the inlets 26 and 28 and follows a path generally designated by the arrows 34 and 36 through the two chambers 38 and 40 and on through the two narrow passageways or gaps 42 and 44 so as to contact the extruded threads 24 as they exit the orifices 20 of the die 16. The chambers 38 and 40 are designed so that the heated, pressurized attenuating gas passes through the chambers 38 and 40 and exits the gaps 42 and 44 to form a stream (not shown) of attenuating gas which exits the die 16 on both sides of the threads 24. The temperature and pressure of the stream of heated attenuating gas can vary widely. For example, the attenuating gas can be applied at a temperature of from about 155 degrees Centigrade to about 200 degrees Centigrade, more particularly, from about 175 degrees Centigrade to about 190 degrees Centigrade. The heated attenuating gas may generally be applied at a pressure of from about 0.5 pounds per square inch, gage to about 20 pounds per square inch gage. More particularly, from about 1 pound per square inch, gage to about 5 pounds per square inch, gage. The position of air plates 46 and 48 which, in conjunction with a die portion 50 define the chambers 38 and 40 and the gaps 42 and 44, may be adjusted relative to the die portion 50 to increase or decrease the width of the attenuating gas passageways 42 and 44 so that the volume of attenuating gas passing through the air passageways 42 and 44 during a given time period can be varied without varying the velocity of the attenuating gas. Furthermore, the air plates 46 and 48 may be adjusted to effect a “recessed” die-tip configuration as illustrated in FIG. 3 or a positive die-tip 22 stick-out where the tip of die portion 50 protrudes beyond the plane formed by the plates 48. Generally speaking, a positive die-tip stick-out configuration and attenuating gas pressures of less than 5 pounds per square inch, gage are used in conjunction with air passageway widths, which are usually the same and are no greater in width than about 0.110 inches. Lower attenuating gas velocities and wider air passageway gaps are generally preferred if substantially continuous meltblown fibers or microfibers 24 are to be produced. The two streams of attenuating gas converge to form a stream of gas which entrains and attenuates the molten threads 24, as they exit the orifices 20, into fibers or, depending upon the degree of attenuation, microfibers, of a small diameter which is usually less than the diameter of the orifices 20. The gas-borne fibers or microfibers 24 are blown, by the action of the attenuating gas, onto a collecting arrangement which, in the embodiment illustrated in FIG. 1, is a foraminous endless belt 52 conventionally driven by rollers 54. The fibers or microfibers 24 are collected as a coherent matrix of fibers on the surface of the endless belt 52 which is rotating as indicated by the arrow 58 in FIG. 1. The vacuum boxes assist in retention of the matrix on the surface of the belt 52. Typically the tip 22 of the die 16 is from about 6 inches to about 14 inches from the surface of the foraminous belt 52 upon which the fibers are collected. The thus-collected, entangled fibers or microfibers 24 are coherent and may be removed from the belt 52 as a self-supporting nonwoven web 56 by a pair of pinch rollers 60 and 62 which may be designed to press the fibers of the web 56 together to improve the integrity of the web 56.

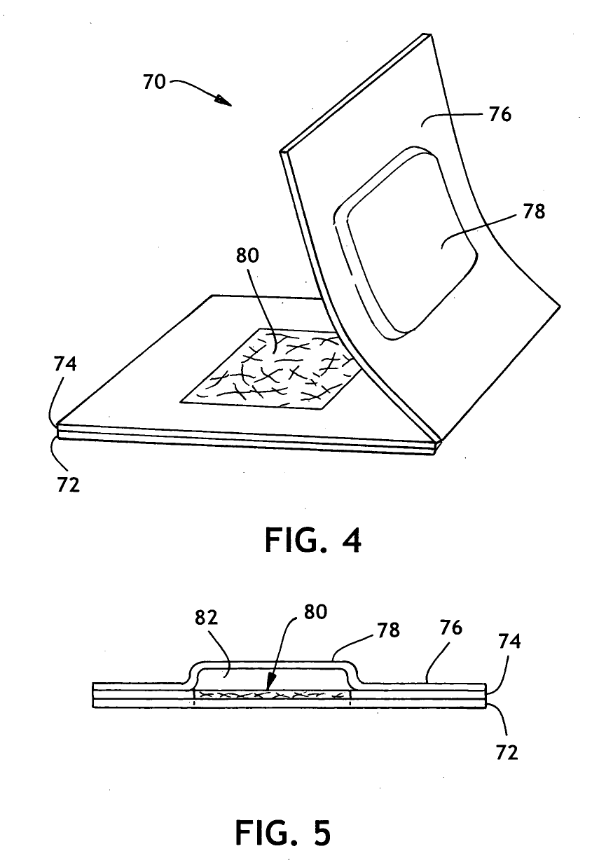

FIG. 4 depicts an exploded perspective view of a transdermal drug delivery device in accordance with the invention. FIG. 5 depicts a cross-sectional view of the transdermal delivery device of FIG. 4. The transdermal delivery device 70 is designed to deliver an active ingredient, either drugs, medicaments, or other treatments, across the skin of a consumer. The delivery device includes an adhesive layer 72, for affixing the device (patch) to the skin of the consumer. The adhesive layer may include a removable protective liner, to protect the adhesive layer during nonuse and also to reduce the likelihood of loss of active ingredient. The adhesive layer may cover the entire lower surface of the transdermal delivery device, or only a peripheral portion of the lower surface, so as not to interfere with the passage of active ingredients across the skin of the consumer. The active ingredient can be stored in a chamber 82 or in the polymer layer 74. If the active ingredient is stored in a chamber, 82, the polymer layer 74 separates the active ingredient from the adhesive layer. If the active ingredient is in the polymer layer, no chamber is necessary. Such polymer layer 74 may be a single component layer, or alternatively, may comprise two materials (as shown) such as 74 and 80. If the polymer layer is made from two or more distinct polymer components, the medicaments may be targeted to narrower areas of skin, depending upon the ability of each polymer component to allow the passage of medicaments. The polymer layer is essentially the skin contacting layer, through which the active ingredient passes after the device is applied to the skin of a consumer. The device further includes a backing layer 76, which includes a raised portion 78, for housing the active ingredient. The active ingredient is allowed to pass through the polymer layer 74/80 but desirably does not pass through the backing layer 76. The polymer material of the present invention may be utilized as the material for forming a polymer layer in the patch, in order to provide the ability to pass medicaments to the skin of a user. Such polymer layer may be for example a film (such as a selectively permeable or apertured film) or nonwoven sheet (such as a spunbond or meltblown, or a combination of such). Such polymer layer may also be in the form of a hydrogel-type material.

While FIGS. 4 and 5 provide one example of a transdermal delivery device/bandage, in accordance with the invention, it should be appreciated that numerous variations are contemplated to be within the scope of the invention. For instance, each of the described layers may be constructed of one or more layers for more defined/targeted or efficient drug application. Further, in the case of a bandage, such drug enclosure 82, and separate polymer layer, may in fact be comprised of an absorbent sheet material, such as a nonwoven, that is designed to either retain exudates from a wound site, or to both retain exudates, and also to release moisture or select medicaments that are stored within the absorbent sheet material. Such nonwoven web, may be, for instance either a spunbond or meltblown nonwoven web, or a combination of such. In such a fashion, the depicted wound dressing/transdermal delivery device can function as either a hydrogel or hydrocolloid. Such a dressing could act to donate moisture, absorb exudates, to release medicaments, or a combination of such. Similar polymeric layers can also be part of transmucosal and vaginal delivery devices, such as those previously described.

For the purposes of illustration, the following examples were prepared in accordance with the invention. However, the examples should not be construed to limit the scope of the invention. The examples in the first set include both reversible and non-reversible hard segment bonds. In the second set of examples which follow, a comparison is made between polymers with mixed thermally reversible bonds and polymers with only reversible or only non-reversible bonds.

### EXAMPLE SET 1

### Example 1

### 2:1 Ratio of Hard Segment to Soft Segment

### 1:1 Ratio of Non-Reversible to Reversible Hard Segment

422.51 g (0.0497 moles) of polyethylene glycol (PEG) 8,000 number average molecular weight, pharmaceutical grade (Polysciences, Inc.) was dried at 80° C. in a vacuum oven for approximately 40 hours. The resin kettle was then equipped with a high torque mechanical stirrer (ca. 300 rpm) and nitrogen/argon inlet/outlet. The temperature of the melted pre-dried PEG was allowed to equilibrate at ca. 70° C. Benzoyl chloride, from Aldrich, (75 microliters) was added with stirring. After one hour, a 2:1 molar ratio of Methylene diphenyl diisocyanate (MDI) from Aldrich, at 24.85 g (0.09941 moles) was added to the PEG to endcap the polymer. All MDI amounts were weighed out in a dry box. After stirring for 2 hours at ca. 75° C., an additional 12.43 g (0.0497 moles) MDI and 8.95 g (0.0497 moles) butanediol (BDO) from Aldrich, was added with stirring. Each time the hard segment component was added, the isocyanate and chain extender was added individually (MDI first) and allowed to thoroughly be stirred for approximately 8-15 minutes before addition of the chain extender. This formed the non-thermally reversible hard segment. After stirring for 2.5 hours at ca. 74° C., 12.43 g (0.0497 moles) MDI was added with stirring. After 45 minutes 6.13 g Resorcinol (1,3 Benzenediol from Aldrich) (0.0556 moles) was added with stirring. After 36 minutes 1 drop of stannous octoate catalyst (Aldrich), was added. This formed the reversible hard segment. After an additional 13 minutes of stirring at 74° C., the polymer was removed from the resin kettle and poured onto a Teflon coated foil and placed in a vacuum oven at 80° C. for 40 hours.

### Example 2

### 2:1 Ratio of Hard Segment to Soft Segment

### 4:1 Ratio of Non-Reversible to Reversible Hard Segment

392.80 g (0.0462 moles) of dried polyethylene glycol (PEG) 8,000 number average molecular weight (as previously described), was equilibrated at ca. 70° C. Benzoyl chloride, (75 microliters) was added with stirring. After one hour, 23.11 g (0.0924 moles) MDI was added. After two hours of stirring at ca. 73° C., 11.55 g MDI (0.0462 moles) and 8.32 g (0.0924 moles) BDO was added. The melt was allowed to stir for two hours at ca. 73° C. and then 2.89 g (0.0116 moles) MDI and 2.21 g (0.0201 moles) Resorcinol was added. It should be noted that the molar excess of aromatic chain extender limited the molecular weight. The mixture was allowed to stir for 20 minutes, and then stannous octoate was added with stirring. After an additional 14 minutes of stirring at 74° C., the polymer was removed from the resin kettle and poured onto Teflon coated foil and placed in a vacuum oven at 80° C. for 40 hours.

### Example 3

### 3:1 Ratio of Hard Segment to Soft Segment

### 1:1 Ratio of Non-Reversible to Reversible Hard Segment

437.83 g (0.05151 moles) of dried polyethylene glycol (PEG) 8,000 number average molecular weight (as previously described), was equilibrated at ca. 70° C. Benzoyl chloride, (80 microliters) was added with stirring. After one hour and 20 minutes, 25.76 g (0.103 moles) of MDI was added. After two hours and 30 minutes of stirring at ca. 75° C., 25.76 g (0.103 moles) of MDI and 13.90 g (0.0155 moles) of BDO was added. The melt was allowed to stir for two hours at ca. 76° C., then 12.88 g (0.0515 moles) of MDI and 6.52 g (0.0592 moles) of Resorcinol was added. As with the previous examples, the molar excess of aromatic chain extender limited the molecular weight. The mixture was allowed to stir for 45 minutes at 74° C., then the polymer was removed from the resin kettle and poured onto Teflon coated foil and placed in a vacuum oven at 80° C. for 42.5 hours.

### Example 4

### 3:1 Ratio of Hard Segment to Soft Segment

### 4:1 Ratio of Non-Reversible to Reversible Hard Segment

421.40 g (0.0496 moles) of dried polyethylene glycol (PEG) 8,000 number average molecular weight (as previously described), was equilibrated at ca. 70° C. Benzoyl chloride, (80 microliters) was added with stirring. After one and a half hours, 24.79 g (0.0992 moles) of MDI was added. After two hours of stirring at ca. 70° C., 24.79 g (0.0992 moles) of MDI and 13.397 g (0.0149 moles) of BDO was added. The melt was allowed to stir for two hours at ca. 75° C., then 3.10 g (0.0124 moles) of MDI and 2.09 g (0.0187 moles) of Resorcinol was added. As with the previous examples, the molar excess of aromatic chain extender limited the molecular weight. The mixture was allowed to stir for 2 hours at 70° C., then the polymer was removed from the resin kettle and poured onto Teflon coated foil and placed in a vacuum oven at 80° C. for 40 hours.

### Example 5

### Reversible Hard Segment

### 3:1 Ratio of Hard Segment to Soft Segment

250 g (0.0312 moles) dried polyethylene glycol (PEG) 8K was equilibrated at ca. 75° C. Benzoyl chloride, (50 microliters) was added with stirring. After 20 minutes 15.6 g (0.0624 moles) MDI was added. The temperature dropped and was brought back to 75° C. After 2 hours, 15.6 g (0.0624 moles) MDI was added with stirring. Five minutes later 10.6 g (0.0964 moles) resorcinol was added. The temperature was raised to 80° C. After one hour, 2 drops of stannous 2-ethyl hexanoate/stannous octoate catalyst was added. After 30 minutes the reaction mixture became viscous and was placed in a vacuum oven to cure at 80° C.

### Example 6

### Non Reversible Hard Segment

### 2:1 Ratio of Hard Segment to Soft Segment

321 g (0.0375 moles) dried polyethylene glycol (PEG) 8K was equilibrated at 70° C. with 75 microliters of benzoyl chloride while stirring. After 50 minutes 18.75 g (0.0750 moles) MDI was added. After 70 minutes at ca. 70° C., 9.374 (0.0375 moles) MDI was added. After 12 minutes of stirring, 6.957 g (0.0773 moles) BDO was added. After 85 minutes the reaction mixture was placed in a vacuum oven to cure at 80° C.

Polymer Characterization of Polymer Samples Made

Molecular Weight Testing:

Weight Average Molecular weights were estimated by gel permeation chromatography (GPC) using an HP 1100 liquid chromatography system with a refractive index detector and a poly(methyl methacrylate) standard.

Melt Index Determination:

Melt Index Procedure. This test measures the rate of extrusion of one inch of molten resins or material through an extrusion plastometer at the approximate processing temperature through an orifice of a specified diameter under prescribed temperature and pressure conditions. ASTM Procedure ASTM D1238-00 “Standard Test Method for Melt Flow Rates of Thermoplastics by Extrusion Plastometer” was followed with the following variations. The temperatures used were those stated in each table. The weight used was always 2.06 kg. The amount of polymer used was not measured, however, in each case the melt-index chamber was filled and packed so as to eliminate air space. Prior to testing and processing the polymer was dried below the melting point at ca. 45° C. in the vacuum oven for 2-3 days and then stored in air tight vacuum containers. The processing temperature was generally adjusted from 140 to 185-205° C. to obtain the desired flow rate for processing of 75-150 g/10 minutes.

Processing Characteristics and Fiber Formation

The thermally reversible and non-thermally reversible polymers were processed to a limited extent on both spunbond and meltblown laboratory scale equipment. Batches were made in one pound and half pound quantities. Weight average molecular weights ranged from 69,000 to 107,000. Most batches had a small weight average molecular weight fraction above 100,000. For the purposes of processing, batches of similar molecular weight were combined using the GPC data and melt-indices determined at 205° C. after grinding and drying the polymer in a vacuum oven.

Spunbond Processing:

All of the produced polymers melt-processed at approximately 205° C. A Haake melt-spinning unit was used for processing, consisting of four zones with temperatures beginning at 180 degrees C. and ending at the die tip at 230 degrees C. The spin plate used was a 6:1 UD, 19 hole plate with a plate diameter of one inch. The forming distance was between 20-40 inches. The polymer was very tacky/adhesive-like to itself and to non Teflon coated surfaces. Fibrous webs could be made with fibers from approximately 10 to 50 microns in diameter.

Meltblown Processing:

The material was processed on a Killion extruder with a six inch die onto a six inch forming wire with vacuum. The forming distance was between 8 to 12 inches. Entirely thermally reversible polyurethanes were processed at 280° F. Die tip pressures were 140 psi. For comparison, entirely non-thermally reversible polyurethanes were processed at 380° F. Die tip pressures varied between 300 to 500 psi. The mixed polyurethanes (containing both thermally reversible and non thermally reversible bonds) were processed at 374° F. The polymers were as described throughout the example section.

The entirely thermally reversible polymers had a low viscosity, suitable for meltblowing. However, the melt strength was insufficient to draw fibers and globules of material tended to form instead of fibers. The fibers tended to spread out to form films upon laying down on the web former, since the polymer had insufficient time to solidify and crystallize. A film-like, very tacky material, that adhered to the forming wire or carrier web was formed. Additionally, the material had little integrity and obviously lost molecular weight even though the initial polymer had good physical characteristics.

The non-reversible butanediol chain extender-based polymer had good melt strength, but its high viscosity formed high die tip pressures. The throughput had to be slowed to approximately 8 g/minute from 17 g/minute. Other than this problem, the polymer formed a slightly tacky but fibrous web.

Neither polymer system had all of the desired characteristics. The mixed polymers were produced (as previously described) with the following chemistries in Table 1:

TABLE 1

| | Hard | Weight | | |
|---|---|---|---|---|
| | Segment/ | Average | Non- | |
| | Soft | Molecular | Reversible/ | |
| Example | Segment | Weight | Reversible | |
| No. | Mole Ratio | M_{w} | Mole Ratio | Melt-Index |
| 1 | 2:1 | 106,460 | 1.00:1 | 96 (145° C.) |
| 2 | 2:1 | 68,360 | 4.00:1 | 69 (185° C.) |
| 3 | 3:1 | 100,180 | 1.00:1 | 109 (185° C.) |
| 4 | 3:1 | 71,020 | 4.00:1 | 41 (145° C.) |

Chain extenders used for this matrix were butanediol (non-thermally reversible) and Resorcinol (thermally reversible). Storage of the polymers was accomplished using vacuum containers and desiccant packaging. In addition, nitrogen sparge was used in the hopper during processing. This greatly diminished degradation of the polymer and improved the processing characteristics.

All four of the mixed Resorcinol/butanediol polymers processed well, forming fibrous webs. The 1:1 non-reversible to reversible, component polymers worked particularly well for forming fibers. Low molecular weight non-reversible polymers had poor fiber forming properties.

Following polymer formation on the Teflon Foils, a review of the color differences of the various polymer formulations was conducted over a period of time. The color review was based on visual observation, with the colors being identified by the following numerical scale. The color data are reflected in the following Table 2.

For the purposes of the Color Chart of Polymer Types: (1=whitest, 5=brown) H.S.=Hard Segment: S.S.=Soft segment: and timing * ±3 months

TABLE 2

| | | Mole | | | |
|---|---|---|---|---|---|
| | Mole Ratio | Ratio | | | Color |
| Polymer Type | NonRev:Rev | H.S.:S.S. | Age* | Form | Rating |
| 100% Thermally | 0:1 | 3:1 | 3 yrs | Spunbond | 4 |
| reversible | | | | | |
| 100% Thermally | 0:1 | 3:1 | 3 yrs | Meltblown | 4 |
| reversible | | | | | |
| 100% Thermally | 0:1 | 3:1 | 3 yrs | Ground | 5 |
| reversible | | | | Particles | |
| 100% Non- | 1:0 | 2:1 | 3 yrs | Meltblown | 1 |
| reversible | | | | | |
| 100% Non- | 1:0 | 2:1 | 3 yrs | Ground | 1 |
| reversible | | | | Particles | |
| 100% Non- | 1:0 | 2:1 | 3 yrs | Cut pieces | 2 |
| reversible | | | | | |
| Mixed | 4:1 | 3:1 | 3 yrs | Meltblown | 2 |
| Mixed | 1:1 | 3:1 | 3 yrs | Meltblown | 1 |
| Mixed | 4:1 | 2:1 | 3 yrs | Meltblown | 1.5 |

In addition to the visual observations of the respective samples, color measurements were performed on the respective samples to quantify the color differences. The nonwoven samples were tested with a Hunter Lab Color Densitometer (D25 DP-9000) using the CIE standard 2° observer and C illuminant. The measurements for each value were set up according to the manufacturer's instructions in the Hunter Lab manual Version 1.6, Jul. 7, 1994. Generally, the following test procedure was followed. Standard ceramic white tiles were used for instrument calibration as described in the manual. A 2.0 inch aperture was used. Specimens were placed so as to fully cover the light aperture so that no light escaped around the edges. Specimens were thick enough to prevent light penetration. The layers of material were compressed against the aperture by hand before each reading. Averages of three readings for each measurement from three different areas of each specimen type were taken. Values for L*, a*, b*, dL*, da*, db* and dE* were obtained directly from the instrument. The entirely non-reversible polyurethane was used as the standard from which other meltblown samples were compared, since the entirely non-reversible samples appeared to demonstrate the least color change over time.

The absolute values for each measurement: L*, a*, b* were recorded as shown in Table 3 below:

TABLE 3

| | Mole Ratio | Mole Ratio | | | | | | | |
|---|---|---|---|---|---|---|---|---|---|
| Polymer Type | NonRev:Rev | H.S.:S.S. | L* | a* | b* | dL* | da* | db* | dE* |
| 100% Non- | 1:0 | 2:1 | 89.62 | 1.70 | 12.93 | 0 | 0 | 0 | 0 |
| Thermally reversible | | | | | | | | | |
| 100% Thermally | 0:1 | 3:1 | 74.57 | 4.46 | 29.14 | −15.04 | 2.77 | 16.22 | 22.74 |
| reversible | | | | | | | | | |
| Mixed | 4:1 | 2:1 | 87.61 | 2.46 | 14.29 | −2.01 | 0.76 | 0.70 | 2.66 |
| Mixed | 1:1 | 3:1 | 86.73 | 4.21 | 09.69 | −2.89 | 2.52 | −3.24 | 5.27 |
| Mixed | 4:1 | 3:1 | 83.45 | 2.94 | 20.52 | −6.17 | 1.25 | 7.60 | 9.96 |

It should be noted that delta E* is calculated in accordance with the following equation:
dE*=SQRT[(L*standard−L*sample)²+(a*standard−a*sample)²+(b*standard−b* sample)²],

The higher the delta E* (or dE*), the greater the change in color. As can be seen from the test results, the mixed thermally reversible and non thermally reversible polymer having a hard segment to soft segment ratio of 2:1 demonstrated the least color change over time. Therefore it is desirable that such polymers demonstrate a color change (dE*) of between about 0 and 10, when compared to a similar entirely non-thermally reversible sample over a period of time. Desirably, such period of time is up to about a year. Even more desirably, such time period is up to about two years. Still, even more desirably, such period is up to about three years. More desirably, such color change is between about 0 and 5. Even more desirably, such color change is less than about 3.

Additionally, the samples were analyzed using a WiYi index under ASTM E313 and D1925 test methods (white/yellow index) using the same Hunter instrument. The following general test method procedures were utilized to perform the analysis.

ASTM Procedures E313 “Standard Practice for Calculating Yellowness and Whiteness Indices from Instrumentality Measured Color Coordinates” and ASTM D1925-70 “Standard Test Method for Yellowness Index of Plastics” were followed with the following variations. Specimens were not measured according to Practices E1164, E308, E331, E1347, E1348 or E1349. Specimens used were all meltblown samples. However, the samples had varying thickness, basis weight, and overall fiber forming capability and therefore varied from an uneven film (where the fibers had melted together,) to a fibrous web. Two measurements of each sample were taken; one in the machine and one in the cross direction. Since the thickness of each sample type varied, the number of layers used varied with each sample, however, the layers used were the number required such that a black background could not be seen through the samples. The appearance of all samples began as a creamy white color. After aging, some had become brown and some remained creamy white. No formal measurement of the dominant wavelength was taken, however. In addition, Munsell hue, value and chroma measurements were not taken. The data from this analysis appears below in Table 4.

TABLE 4

| | Mole Ratio | Mole Ratio | Wi | Yi | Yi |
|---|---|---|---|---|---|
| Polymer Type | NonRev:Rev | H.S.:S.S. | E313 | D1925 | E313 |
| 100% Non- | 1:0 | 2:1 | 10.48 | 29.26 | 21.50 |
| Thermally | | | | | |
| reversible | | | | | |
| 100% Thermally | 0:1 | 3:1 | −21.05 | 40.23 | 60.57 |
| reversible | | | | | |
| Mixed | 4:1 | 2:1 | 6.38 | 30.30 | 23.15 |
| Mixed | 1:1 | 3:1 | 5.51 | 32.42 | 22.32 |
| Mixed | 4:1 | 3:1 | −14.07 | 45.97 | 31.40 |

The absorbency of the meltblown and spunbond webs was also evaluated using a series of tests. Additionally, the effects of glycerin on the absorbency properties of these materials was evaluated. It was postulated that glycerin or other similar hydrophilic compound or polymer present in a fibrous web would draw and keep some moisture in the polymer, softening it and improving wicking properties. It was determined that glycerin demonstrated a more pronounced effect on the meltblown materials as opposed to the spunbond. In the case of the meltblown, the effect appeared to be an overall affect of increasing the absorbency. Nevertheless, it was determined that about a 5% concentration of glycerin in water is an appropriate amount to hydrate the meltblown and spunbond webs. Ultimately, it was determined that webs made from the inventive polymer demonstrated the capability of both absorbing and donating fluid.

Disclosure of the presently desirable embodiments of the invention is intended to illustrate and not to limit the invention. It is understood that those of skill in the art should be capable of making numerous modifications without departing from the true spirit and scope of the invention.

1. A thermally reversible hydrophilic polymer adapted for use in meltblowing, spunbonding or film extrusion processes, the polymer comprising:
soft segments and hard segments, wherein said soft segments are joined to hard segments with a combination of both thermally reversible bonds and non-thermally reversible bonds, and further wherein said mole ratio of hard segments to soft segments is between about 2:1 and 4:1, and wherein the ratio of non-reversible bonds to reversible bonds is between about 1:1 and 4:1.

2. The thermally reversible polymer of claim 1 wherein the ratio of hard segments to soft segments is between about 2:1 and 3:1.

3. The thermally reversible polymer of claim 1 wherein the ratio of non-reversible bonds to reversible bonds is between about 1:1 and 3:1.

4. The thermally reversible polymer of claim 1 wherein each of the prepolymer segments which make up the polymer is of high molecular weight.

5. The thermally reversible polymer of claim 4 wherein the molecular weight of each of the pre-polymers is greater than about 3,000.

6. The thermally reversible polymer of claim 4 wherein the molecular weight of each of the pre-polymers is between about 3,000 and 50,000.

7. The thermally reversible polymer of claim 4 wherein the molecular weight of each of the pre-polymers is between about 8,000 and 20,000.

8. A meltblown or spunbond web comprising the thermally reversible polymer of claim 1.

9. A spunbond or meltblown web of claim 8 that has been treated with glycerin.

10. A drug delivery device that comprises the web of claim 8.

11. A bandage/wound care dressing that comprises the web of claim 8.

12. The thermally reversible polymer of claim 1 having a weight average molecular weight of between about 70,000 and 100,000.

13. The polymer of claim 1 having a weight average molecular weight of between about 80,000 and 90,000.

14. Fibers formed from a thermally reversible polymer comprising:
a soft segment selected from the group including:
hydroxyl terminated polymers and amine terminated polymers; and
a hard segment including:
at least one aromatic multifunctional isocyanate; and a chain extender having at least two functional groups capable of reacting with the isocyanate, at least one of the functional groups being a hydroxyl group attached to an aromatic ring, wherein said mole ratio of hard segments to soft segments is between about 2:1 and 4:1, and wherein the ratio of non-reversible bonds to reversible bonds is between about 1:1 and 4:1

15. The fibers of claim 14 wherein said chain extender is selected from the group including aromatic diols and aromatic triols having at least one aromatic hydroxyl group and blends of at least one of said aromatic diols or triols with at least one aliphatic diols or aliphatic triols.

16. The fibers of claim 14 wherein said hydroxyl terminated polymer is selected from the group including polyethylene glycol, polytetramethylene ether glycol, polyethylene adipate diol, polycaprolactone diol, polysiloxane diol and polypropylene glycol.

17. The fibers of claim 14 wherein said multifunctional isocyanate is selected from toluene diisocyanate and methylene diphenyl diisocyanate.
